(19) United States
(12) Patent Application Publication
(10) Pub. No.: US 2018/0251005 A1
(43) Pub. Date: Sep. 6, 2018

(54) CONNECTOR FIOR SECTIONS OR MODULES FOR HVAC SYSTEM

(71) Applicant: SYSTEMAIR AB, Skinnskatteberg (SE)

(72) Inventors: Johnny BERGMAN, Fagersta (SE); Raine SORVOJA, Fagersta (SE); Amdal OYSTEIN, Fagersta (SE); Daniel SALO, Eidsvol Verk (NO); Orkun YILMAZ, Merter (TR); Ralph BERGER, Gladbeck (DE); Rafael SONNEK, Duesseldorf (DE); Tomas STONCIUS, Ukmerge (LT); Thomas Sondergard HANSEN, Viby J (DK); Ulf BANG, Horsens (DK); Andy BIJMANS, TG's-Hertgenbosch (NL); Peter KIEVITS, Waspik (NL)

(21) Appl. No.: 15/753,326

(22) PCT Filed: Jul. 20, 2016
(86) PCT No.: PCT/EP2016/001268

§ 371 Date: Feb. 18, 2018

(30) Foreign Application Priority Data
Sep. 24, 2015 (DE) 10 2015 012 407.2

(51) Int. Cl. B60H 1/00; F16B 5/00

(52) U.S. Cl. CPC B60H 1/00528; F16B 2/241; F16B 5/0016; B60H 1/00542

(57) ABSTRACT

The invention relates to a housing connecting device for connecting two housing sections or housing modules of a ventilation or air-conditioning system to each other, with at least in each case two first connecting elements (1) which are fastened to the operating and rear side of a first housing section or of a first housing module, with in each case at least one pawl (3), with at least in each case two second connecting elements (2) which are fastened to the operating and rear side of an adjacent second housing section or of an adjacent second housing module and each have one latching tooth (Z1) or two latching teeth (Z1, Z2) for preliminary latching and final latching of the pawl, wherein the connecting elements are attached either on the outer side or inner side of the housing sections or housing modules.

The invention relates to a connector for connecting two housing sections or modules of an HVAC system to each other.

When assembling and installing an HVAC system comprising individual housing sections or modules, it is often difficult to fasten together the parallepipedal housing sections or modules since the rear faces thereof are often not accessible for screwing together the parts. Often, no accessibility is provided, either from the outside or from the inside.

It is the object of the invention to provide a connecting system that is structurally simple and easily handleable that can fasten together parallepipedal housing sections or modules of an HVAC system in a simple and secure manner without the use of tools and even in inaccessible situations. Moreover, the shape of the connector, in combination with the use of at least two respective connectors on the operating face and rear face of the systems, is designed to permit a “self alignment” of the sections in all spatial axes X, Y, Z.

This object is achieved according to the invention by

at least two first connecting elements that are fastened to the operating face and rear face of a first housing section or module, each with at least one locking pawl,

at least two respective second connecting elements that are fastened to the operating face and rear face of an adjacent second housing section or module, each having two latch teeth for preliminary latching and final latching of the locking pawl, wherein the connecting elements are optionally attached on the outer face or inner face of the housing sections or modules.

To this end, it is preferably proposed that, when engaging the locking pawl in the preliminary latching position, the two connecting elements form a spacing between one another and when engaging the locking pawl in the final latching position the two connecting elements bear against one another.

By this construction according to the invention it is possible to fasten the housing sections or modules of an HVAC system in a first aligned preliminary position, in rough alignment with one another in a first latching step, in order to obtain subsequently the complete definitive connection in exact alignment in the second latching step, by pressing together further by hand or using aids. These component connectors according to the invention, therefore, make it possible to reach a first preliminary position and subsequently to obtain the exact, fixed and definitive fastening position by simple handling and without the use of tools. In this case, the two fastening elements of the component connecting device are of simple and robust construction and thus easy to produce and simple to handle. Whilst the housing modules or housing sections are still accessible all around, the connecting elements may be easily screwed to the side walls. Subsequently, the modules or sections only need to be pressed into the preliminary position in order to be definitively pushed against one another.

The connector does not necessarily have to be provided with double latching. When dispensing with the preliminary latching, only the pre-alignment function is absent. The essential functional principle remains even when a single final latching is exclusively used.

A structurally secure and fixed hold is provided when the first connecting element as a locking pawl has a spring tongue, the free end thereof forming a latching lug. In this case, the spring tongue may be formed by a spring plate.

In order to obtain an accurate guidance and a secure hold of the connecting elements against one another, it is proposed that at least one of the two connecting elements comprises at least one projecting region that is aligned so as to protrude in the direction of movement of the two connecting elements relative to one another and after fastening the two connecting elements to one another is inserted positively into a recess of the other connecting element.

Preferably, it is proposed that one connecting element comprises a projection and two recesses and the other connecting element comprises two projections and a recess for a positive connection. It is also advantageous if the connecting elements consist of plastics or metal. In this case, the connecting elements may comprise bores for screws for fastening to the side walls of the housing sections or modules.

It is particularly advantageous if, when the appliance modules or sections are pushed together or pulled together, the projecting regions and recesses by their shape align the modules or sections relative to one another in all three spatial axes. It is also advantageous if the connecting elements and thus the housing sections or modules, in combination with the locking pawl, may be connected together without the use of tools. Moreover, it is proposed that the releasability and/or separability of the connectors and thus of the housing modules or sections is ensured by selectively removing the locking pawls on the operating face or rear face.

Since one of the faces is always accessible and the locking pawls are only attached by means of a releasable screw connection, the dismantling thereof is designed to be very simple.

An exemplary embodiment of the invention is shown in the drawings and is described hereinafter in more detail. In the drawings:

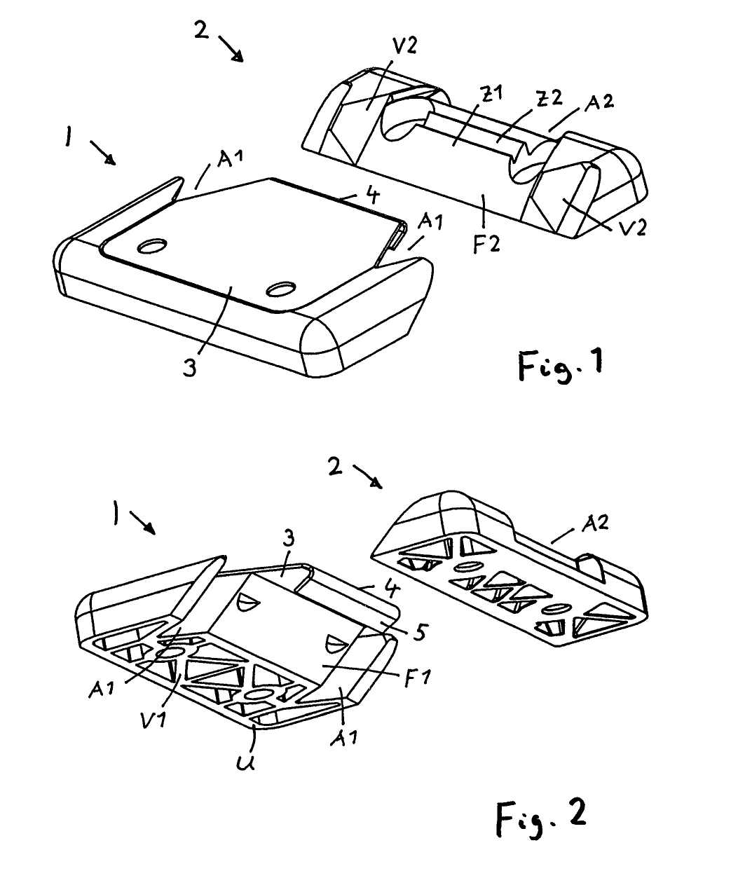

FIG. 1 is a first perspective view of the two connecting elements in the state not yet assembled,

FIG. 2 is a second perspective view of the two connecting elements in the state not yet assembled,

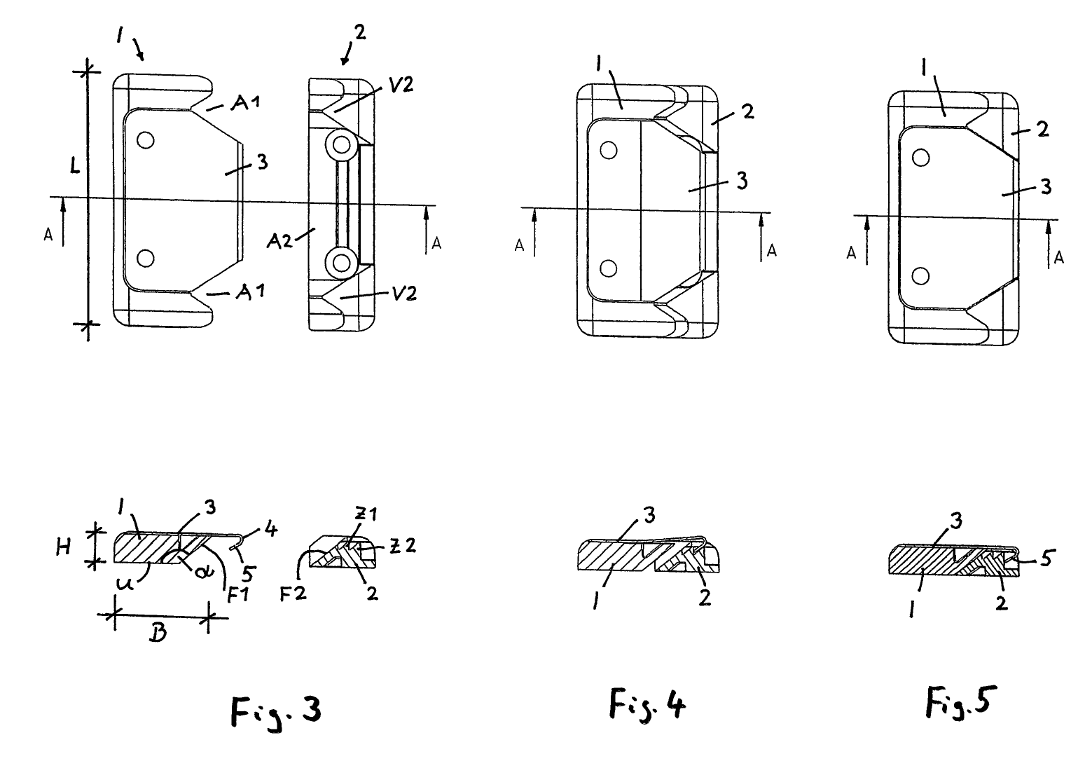

FIG. 3 shows the two connecting elements in plan view and section in the unassembled state,

FIG. 4 shows the connecting elements according to FIG. 3 in the first latching step,

FIG. 5 shows the connecting elements according to FIGS. 3 and 4 in the second latching step.

The device is a two-part component connector for connecting housings of modules or sections of ventilation or air-conditioning systems. In this case, each section or each module has a single parallepipedal external housing that surrounds air-guiding appliances by means of external profile frames and side walls, in particular panels. In order to connect together the housing sections and/or housing modules so that the entire system is subsequently produced, connecting elements 1, 2 are screwed at the same height onto the, in particular, perpendicular side walls of the sections or modules, the connecting elements engaging in one another after the sections/modules are pushed together in order to provide a fixed hold of two sections/modules against one another. In this case, the connecting elements 1, 2 are fastened to the external surfaces or internal surfaces of the sections/modules, so that the front faces of the sections/modules may be tightly fastened together and without intermediate spaces/gaps.

The two solid connecting elements 1, 2 made of solid material (plastics or metal) are designed such that they fit positively into one another. The first connecting element 1 has the shape of an elongated parallepipedal block with a larger width B than the height H and a longer length L than the width B, wherein a side surface arranged over the length L serves as a bearing surface F1 for the second connecting element 2 and is obliquely arranged so that the bearing surface F1 forms an internal angle of 120 to 150°, preferably of 140°, relative to the lower surface U.

The bearing surface F1 forms a central projecting region V1 between two lateral recesses A1. A locking pawl 3 in the form of a spring tongue made of spring plate bears against the upper face of the connecting element 1, fastened by screws 6 or rivets, the locking pawl on its longitudinal edge 4 protruding over the block on the longitudinal side, forming a latching lug 5 parallel to the bearing surface F1. The screws 6 penetrating the locking pawl serve at the same time for fastening the connecting element 1 to the housing of the section or the module.

The second connecting element 2 has the same height H and the same length L as the first connecting element 1 and has a smaller width than the width B of the first connecting element 1. The bearing surface F2 of the second connecting element 2 has the same oblique angle as the angle of the first connecting element 1, so that after finally pushing together the sections or modules, the oblique bearing surfaces F1 and F2 bear against one another. In this case, the bearing surface F2 forms two V-shaped, lug-shaped projections V2 that in shape and size correspond to the V-shaped recesses A1. Moreover, the bearing surface F2 forms a central recess A2 that in shape and size corresponds to the projecting region V1, so that the two bearing surfaces F1 and F2 positively fit into one another. In this case, the lateral oblique surfaces of the recesses A1, A2 and the projections V1 and V2 have centering guiding functions when two housing sections or modules are pushed against one another.

The upper face of the second connecting element 2 forms two latch teeth Z1, Z2, the tooth tips thereof extending parallel to the longitudinal alignment of the second connecting element 2 and parallel to the latching lug 5 of the latching pawl 3. When the sections or modules and thus the connecting elements 1, 2 are pushed together relative to one another, in the preliminary latching position the latching pawl 3 engages with its latching lug 5 behind the first latching tooth Z1. If the sections or modules are then pushed into their final position, the latching lug 5 engages behind the second latching tooth. Thus, a secure fastening of the housing sections or modules onto one another may be achieved in a simple manner and without the use of tools.

The releasability of this connection is possible by the removal of the locking pawls on one side. Subsequently, the housing sections or modules may be pulled apart and/or pushed apart again.

On the perpendicular side walls of two housing sections or modules to be fastened together, it is invariably the case that one connecting device is not only fastened by two connecting elements 1, 2 but generally two to four connecting elements 1, 2 (connecting element pairs) so that a secure hold is provided.

When the appliance modules or sections are pushed together or pulled together, the projecting regions V1, V2 and recesses A1, A2 align, by their shape in the vertical direction, the modules or sections relative to one another. By the shape of the bearing surfaces F1, F2 and the arrangement of at least two respective connectors on the operating face and rear face of the housing modules or sections, the appliance modules or sections are also aligned in the depth direction. By the arrangement of at least two respective connectors on the operating face and rear face, in the preliminary latching position and final latching position, the appliance modules or sections are also aligned in the longitudinal direction. In summary, when using the connectors the appliance modules or sections are aligned in all three spatial axes X, Y, Z.

The housing sections or modules may be connected together in combination with the locking pawl 3 and without the use of tools. A further connection of the connecting elements 1, 2 to one another is not present. Moreover, the releasability and/or separability of the connectors and thus of the housing modules or sections is ensured by removing the locking pawls on the operating face or rear face.

1. A connector for connecting two housing sections or modules of an HVAC system to each other, the connector comprising:
two first connecting elements fastened to an operating face and a rear face of a first housing section or module, each with at least one locking pawl, and
two second respective connecting elements fastened to the operating face and rear face of an adjacent second housing section or module, each having one or two latch teeth for preliminary latching and final latching of the locking pawl.

2. The device according to claim 1, wherein when engaging the locking pawl in the preliminary latching position, the two connecting elements form a spacing between one another and when engaging the locking pawl in the final latching position the two connecting elements bear against one another.

3. The device according to claim 1, wherein the first connecting element is a locking pawl having a spring tongue having a free end forming a latching lug.

4. The device according to claim 3, wherein the spring tongue is formed by a spring plate.

5. The device according to claim 1, wherein at least one of the two connecting elements comprises at least one projecting region that is aligned so as to protrude in the direction of movement of the two connecting elements relative to one another, and after fastening the two connecting elements to one another is inserted positively into a recess of the other connecting element.

6. The device according to claim 5, wherein a connecting element comprises a projection and two recesses and the other connecting element comprises two projections and a recess for a positive connection.

7. The device according to claim 1, wherein the connecting elements consist of plastic or metal.

8. The device according to claim 1, wherein the connecting elements are formed with bores for screws for fastening to the side walls of the housing sections or modules.

9. The device according to claim 1, wherein, when the appliance modules or sections are pushed together or pulled together, the projecting regions and recesses by their shape align the modules and sections relative to one another in three spatial axes.

10. The device according to claim 1, wherein the connecting elements and thus the housing sections or modules in combination with the locking pawl may be connected together without the use of tools.

11. The device according to claim 1, wherein the releasability and/or separability of the connectors and thus of the housing modules or sections is ensured by removing locking pawls on the operating face or rear face.
